(19) United States
(12) Patent Application Publication
(10) Pub. No.: US 2005/0181336 A1
(43) Pub. Date: Aug. 18, 2005

(54) System and method for learning letters and numbers of a foreign language

(76) Inventor: Kalust C. Bakalian, Long Island City, NY (US)

Correspondence Address: Richard C. Litman;LITMAN LAW OFFICES, LTD., P.O. Box 15035, Arlington, VA, 22215, US

(21) Appl. No.: 10/921,819

(22) Filed: Aug. 20, 2004

Related U.S. Application Data
(60) Provisional application No. 60/544,494, filed on Feb. 17, 2004.

(51) Int. Cl. G09B 19/06; G09B 19/08

(52) U.S. Cl. 434/157

(57) ABSTRACT

A system and method of teaching letters and numbers of a foreign language. The system includes at least one server computer having a processor, an area of main memory for executing program code under the direction of the processor, a storage device for storing data and program code and a bus connecting the processor and storage device. There is also at least one relational database stored on the storage device and a data communications device connected to the bus for connecting the server computer to the Internet. This includes using the Internet for teaching alphabet letters and numbers of a foreign language computer program code stored in the storage device and executing in the main memory under the direction of the processor.

### CROSS-REFERENCE TO RELATED APPLICATION

This application claims the benefit of U.S. Provisional Patent Application Ser. No. 60/544,494, filed Feb. 17, 2004.

### BACKGROUND OF THE INVENTION

1. Field of the Invention

The present invention relates to educational language software and an Internet Web site whereby persons can learn numbers and letters of a foreign language.

2. Description of the Related Art

With the development of the Internet and the use of computer software products, it is becoming easier for people to gather and organize information. One particular area of interest is using software and the Internet to teach and learn a foreign language. This is reflected in the following related art.

United States Patent Application Publication No. 2002/0058234 published on May 16, 2002, outlines the use of a system and method for teaching a language with an interactive digital television. In one embodiment, audio and visual material in a digital format is presented on an interactive digital television, exposing the user to a predetermined amount of foreign language content that is progressively increased over time.

United States Patent Application Publication No. 2002/0160341 published on Oct. 31, 2002, outlines the use of a speech recognition unit and a processor unit of a foreign language-learning device. Sentence speech information corresponding to a sentence pronounced by a learner is received and separates the information into word speech information on the basis of words included in the sentence. The processor unit evaluates the degree of matching of the word speech information with model speech, and a resultant evaluation is indicated on a display unit on the basis of each word.

United States Patent Application Publication 2002/0182571 published on Dec. 5, 2002, outlines the use of a system and method relating to online education courses. More specifically, the system and method relate to teaching foreign languages over a computerized network.

United States Patent Application Publication 2003/0040902 published on Feb. 27, 2003, outlines a system of learning a foreign language that includes a document-receiving module, a document-partitioning module and a sentence-dividing module. The document-receiving module receives a language document entered by a learner. The document-partitioning module partitions the language document into at least one independent sentence. The sentence-dividing module divides the independent sentence into a plurality of elements.

United States Patent Application Publication 2003/0108854 published on Jun. 12, 2003, outlines the use of a book mainly used by children and students that have a speech circuit. A printed circuit board containing press triggers is placed inside the cover of the book. A number of speech switches in the book correspond to the positions of pictures in the book. In the book, the speech circuit includes a circuit for storage and sound emission, a speaker and a battery, all of which are in a box-like container linked with the book.

United States Patent Application Publication 2003/0143516 published on Jul. 31, 2003, outlines the use of a teaching method that uses a two-sided learning aid called the one page book. A combination of two languages are used in which the syntax of the target language is set up to allow the student to learn how to speak, think, write, read and understand the target language. This portable, always accessible and easy-to-use learning aid will allow the student to spontaneously communicate within 120 hours of formal language training by just following the numerical sequence found in the learning aid.

U.S. Pat. No. 4,144,656 issued to Podkopaev et al. on Mar. 20, 1979, outlines the use of a teaching machine for studying foreign and native languages that has a task unit for a program of successive algorithmic exercises having unambiguous solutions, a machine control unit, an answer input unit, an answer analyzing unit, a signaling unit, a reference unit and a decoder. The task-setting unit is provided with a detachable programmer made as a memory unit of the task unit and the answer input unit, thus ensuring programming of any algorithmic exercise from any conventional textbook.

U.S. Pat. No. 4,690,644 issued to Flanders et al. on Sep. 1, 1987, outlines the use of an apparatus for use with a carrier of information that is to form the subject matter of a lesson. There is also a keyboard having its keys marked with symbols, which include those related to the carrier of information. There is also a visual display unit having a screen and a computer, which is programmed in relation to the carrier of information to check the accuracy of a student's transcription by indicating on the screen, the performance of the student.

U.S. Pat. No. 6,319,010 issued to Kikinis on Nov. 20, 2001, outlines the use of an interactive system for teaching and entertaining a child such as a doll, the doll having input and output elements and a bi-directional communication link to a personal computer. Scripted data stored at the computer directs doll activity and verbal articulation and utilizes responses from the child through the doll to the personal computer in directing output to the doll.

U.S. Pat. No. 6,325,630 issued to Grabmayr on Dec. 4, 2001, outlines the use of a foreign language-learning device, particularly in a form similar to a vocabulary book or notebook, giving the foreign language terms to be learned. It is intended for use as a reproduction or a depiction holder having several labels and information carriers or holders, wherein the labels and information carriers or holders are at least provided with an adhesive or holder section.

U.S. Pat. No. 6,341,958 issued to Zilberman on Jan. 29, 2002, outlines the use of a method and system for learning a foreign language by first switching-off subconscious translation into a native language with the help of special drills such as simultaneously reading a lesson in a foreign language, recording the lesson and repeating the lesson.

U.S. Pat. No. 6,435,876 issued to Chen on Aug. 20, 2002, outlines the use of an instructional process identifying a word or sentence having a sound that is difficult to pronounce or that is often confused. The process also includes training to hear the sound accurately, while viewing mouth movements when making the sound and pronouncing the word or sentence. The process further includes recording mouth movements when pronouncing the word or sentence, sending a recording of the mouth movement to an instructor and reviewing feedback from the instructor.

European Patent Number 95250010.6 granted to Bishop on Jan. 26, 1995, outlines the use of an interactive audio-visual foreign language skills maintenance system. The system uses a computer, responsive to user input that controls the presentation of an audio-visual work to a user. Through the selection of several interactive learning options, support and reinforcement of the learning process is provided. In particular, the computer interacts with the user to challenge the user's understanding of the audio-visual work.

German Patent Number DE 19547742 granted to Lemoine on Jul. 10, 1997, outlines the use of a display system with programmed symbols and sounds for learning foreign languages. The system allows visual symbols and phonetic sounds to be suitably selected and displayed on a screen or repeated audibly until a stop signal is given. The symbols are selected by a human finger, a light pen, a keyboard or a microphone. The symbols and sounds are stored on CD-ROM. Symbols and sounds are reproduced after input is completed, e.g. by drawing along the outline of a symbol with a finger on a touch screen.

W.I.P.O. Patent Number WO 00/22597 granted to Topolewski et al. on Apr. 20, 2000, outlines the use of a foreign language instruction method for computer-aided language instruction. The method can be used by a student utilizing a multi-media computer in which the computer is programmed to display virtual settings that would be encountered by a foreign student in everyday life in the country of the foreign language being learned. The computer is also programmed to create a virtual host that is appropriate for that setting, and to allow, through the use of automatic speech recognition and natural language understanding technologies, a real life conversation to occur between the student and the host that is appropriate to the setting.

French Patent Number FR 2790586 granted to Muller on Sep. 8, 2000, outlines the use of an interactive learning speech recognition technique. During repetition of words being learnt, incorrect pronunciation is separated from correct pronunciation word parts. Phrases are recognized from the vocabulary and the nearest incorrect word is found with respect to the reference phrase. The speech recognition interactive learning technique also has a vocabulary base containing different words.

European Patent Number EP 1058223 granted to Zotova on Dec. 6, 2000, relates to a method for teaching foreign languages that shows students a plurality of color demonstration systems in which all basic words are indicated in black and blue, while distinct words or parts thereof are indicated in green and new words are indicated in red.

Japanese Patent Number JP 2002366018 granted to Iwamura on Dec. 20, 2002, outlines the use of a foreign language learning system, which is provided with a basic dictionary database in which each word is applied an attribute according to class such as a beginner's class or an advanced class.

Although each of the inventions described in each patent and publication are useful and novel, what is really needed is a software and computerized method that can be used to learn numbers and letters of a foreign language. Such software and a computerized method are becoming more in great demand considering the many different languages spoken in many parts of the world.

None of the above inventions and patents, taken either singularly or in combination, is seen to describe the instant invention as claimed. Thus a foreign language teaching aid solving the aforementioned problems is desired.

### SUMMARY OF THE INVENTION

The invention is a system and method for teaching persons numbers and alphabet letters of a foreign language. The system includes at least one server computer having a processor, an area of main memory for executing program code under the direction of the processor, a storage device for storing data and program code and a bus connecting the processor and storage device. There is also at least one relational database stored on the storage device and a data communications device connected to the bus for connecting the server computer to the Internet. This includes using the Internet for teaching alphabet letters and numbers of a foreign language computer program code stored in the storage device and executing in the main memory under the direction of the processor.

Accordingly, it is a principal object of the invention to provide software for teaching persons numbers and alphabet letters of a foreign language.

It is another object of the invention to provide a Web site where persons can learn the numbers and letters of a foreign language.

It is a further object of the invention to provide persons the capability to color an image on a computer monitor or print out the image and color the printed image.

Still another object of the invention is to provide software and a Web site that teaches its users letters of the Armenian language.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an example of an alphabet letter and number functioning process for the Armenian language according to the system and method of teaching letters and numbers of a foreign language.

FIG. 2 is an overview of a system of teaching letters and numbers of a foreign language according to the present invention.

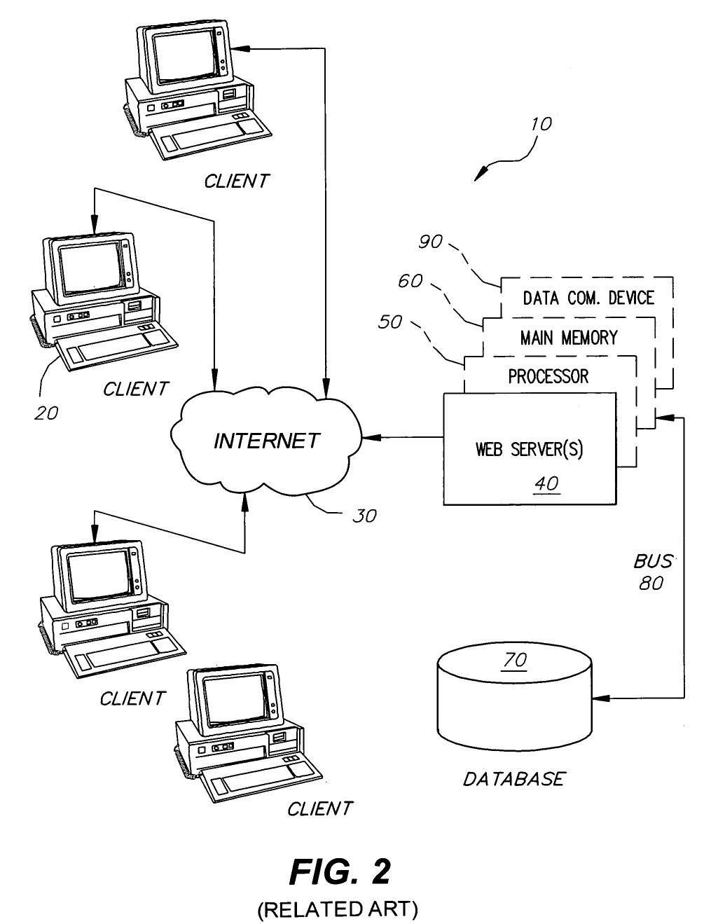

FIG. 3 is an outline of registration information required by the system and method of teaching letters and numbers of a foreign language.

FIG. 4 outlines the various functions of the system and method of teaching letters and numbers of a foreign language.

Similar reference characters denote corresponding features consistently throughout the attached drawings.

### DETAILED DESCRIPTION OF THE PREFERRED EMBODIMENT

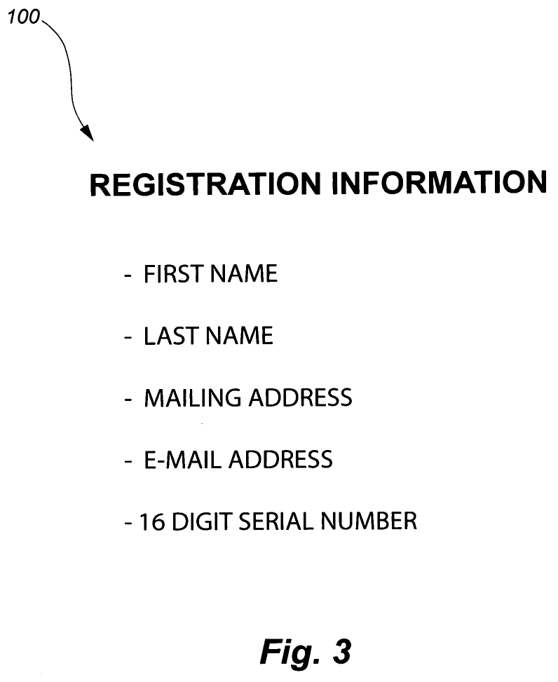

The present invention is a computerized system 10, in which the present invention operates, as shown in FIG. 3. The computerized system 10 uses a client-server model, including a plurality of clients 20 connected to a Web server 40 through a computer network, preferably the Internet 30, although the computerized system 10 may also operate on an intranet or extranet. The Web server 40 has a processor 50 for processing instructions and an area of main memory 60 for executing program code under the direction of the processor 50 connected by a bus 80.

The computerized system 10 also includes at least one relational database 70 for storing data. The relational database(s) 70 may reside in an area of disk storage on the Web server 40 and be connected to the main memory by the bus 80, or may reside on a remote database server accessible by the Web server 40, as is known in the art. A data communications device 90 is connected to the bus 80 for connecting the Web server 40 to the Internet 30. The client computers 20 have a Web browser operable thereon for receiving and viewing documents written in Hypertext Markup Language (HTML) and are transmitted over the Internet 30 via Hypertext Transfer Protocol (HTTP) by the Web server 40 and transmit requests for HTML documents to the Web server 40 via HTTP.

The present invention includes software program code stored on a computer readable medium and is operable in main memory on the Web server 40 for teaching letters and numbers of a foreign language, which are accessible to a client computer 20 through the Internet 30. As used in the present application, the term “computer readable medium” refers to a hard disk drive, a floppy diskette, a ZIP disk or any other magnetic storage media capable of storing coded program instructions, an optical or laser storage device, such as a compact disk, laser disk, paper tape, punch cards or any other media for the storage of program instructions readable by a disk storage device or reader. The computer code may be written in Java□ (Java is a trademark of Sun Microsystems), HTML, XML or Microsoft's Active Server Pages (ASP), and includes code for teaching letters and numbers of a foreign language.

A Web-based overall method for customizing a design for teaching letters and numbers of a foreign language 105 has computer program code that is in the storage device and executes in the main memory 60 under the direction of the processor 50. The computer program includes a Web server software means for teaching letters and numbers of a foreign language for at least one Web site on the Internet 30.

FIG. 3 outlines the registration information 100 required to use the computerized system 10. This registration information 100 includes a user's first name, last name, full mailing address, e-mail address and 16-digit serial number that is provided on the back of a CD-ROM purchased by the user. The user must register the 16-digit serial number or the computerized system 10 will not work. It is only after the user submits the registration on the Web site that the user will be able to install the program.

Although the computerized system 10 and overall method 105 can be applied to teach a user alphabet letters and numbers from any foreign language, the letters of the Armenian language will be used as an example. The Armenian language has 38 letters, with each individual letter outlined and addressed in each individual lesson. Every letter, its animation and its characters have been individually outlined in the computerized system 10. When a letter or an object is clicked on the computerized system 10, the software program “Macromedia Flash—loadMovie” command is used to open all of the letters and objects. “Macromedia Flash” is required for the user to view all of the letters and animations and can be downloaded for free at the Web site. Each object and character has their own respective file and the “LoadMovie” command is used at all times to open these files.

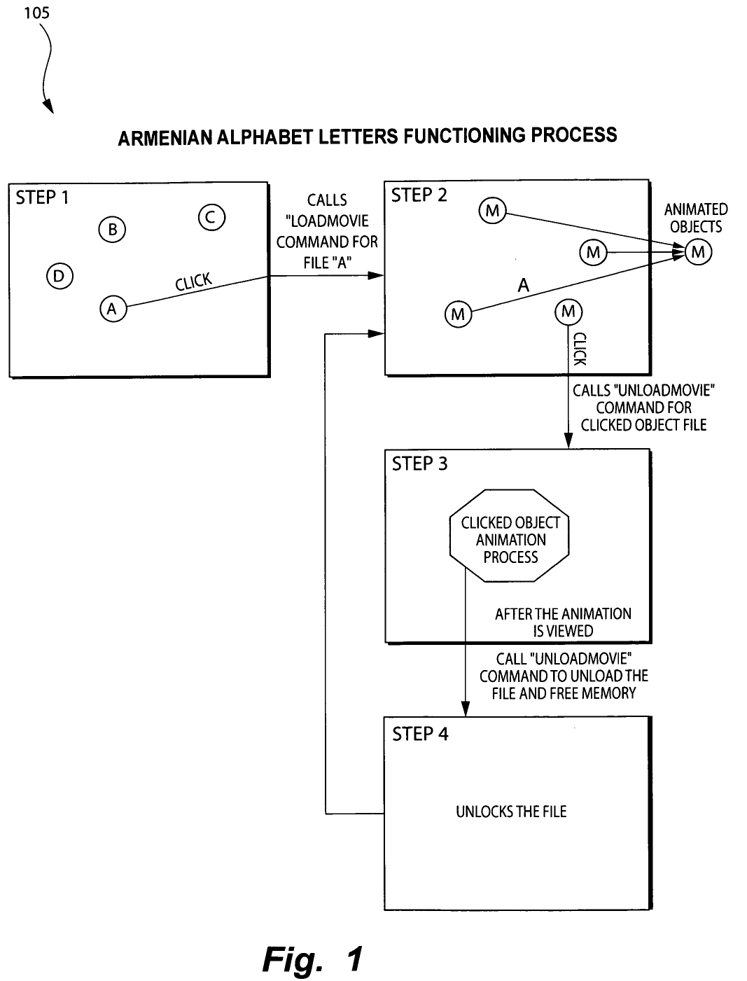

FIG. 1 outlines the steps taken to execute the overall method 105 that are performed by the computer program product software. These steps include selecting an alphabet letter or number of a foreign language, selecting an animated object associated with the alphabet letter or number, viewing an animated process associated with the animated object and ending the computerized method. Every time the “loadMovie” command is used, an object or a character will make a movement. After a movement is over, the “unloadMovie” command is used to remove the existing file for freeing memory in their computer, so that a user can continue to use their computer without worrying that their computer will freeze or crash.

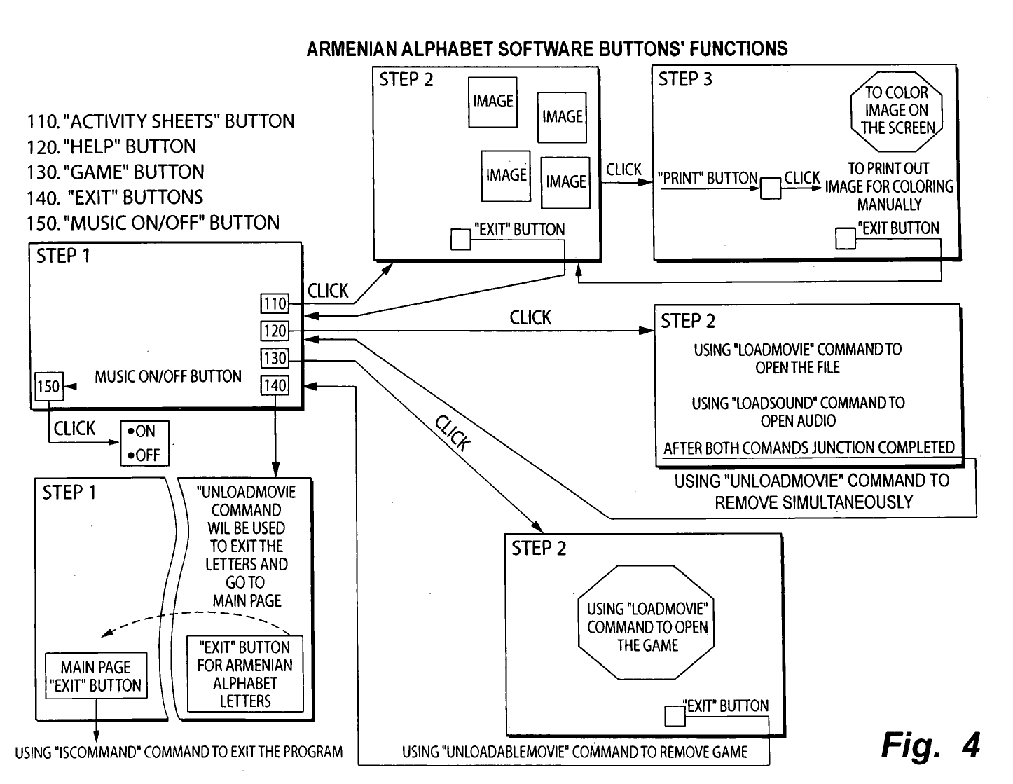

As outlined in FIG. 4, when an Armenian letter or an object is clicked, a window will be displayed with a lesson following the letter or object. There are 5 functions that are loaded onto a user's hard drive, which include an activity sheets function, a help function, a game function, a music function and an exit function. All of these functions are outlined and depicted in FIG. 4.

First, the activity sheets function will use an activity sheets button 110 that will use the “loadMovie” command to show several different images on the computer screen. By clicking on the “loadMovie” command, the image will be opened. The user will have an option to color the activity sheet on the computer screen or by clicking the print button for the print command to also-print the activity sheet and to color it manually.

The activity sheets function will use the “loadmovie” command to show several different images on the computer screen. By clicking on the image, the “loadMovie” command will be used to open the image. As discussed, the user will have an option to color the activity sheet on the computer screen or by clicking the Print button to print the activity sheet and color it manually.

The help function can also be used. When the help button 120 is clicked, the user will be guided with audio instructions. The “LoadMovie” command will be used to help animation movements and the “loadSound” command will be used for the audio. A start command will also be used for the audio and the animation to work together simultaneously.

When the help button 120 is clicked, there are 2 files, a movement file and a sound file that are used as part of the help function. The movement file will function with the “loadMovie” command and the sound file will function with the “loadSound” command. “LoadSound” will also work simultaneously with the start for the audio instructions. After the help function is completed, an “unloadMovie” command will be used to remove that file.

There is also a games button 130 that will function with the “loadMovie” command to display any games. When the user wants to exit the game, the “unloadMovie” command will be used for exiting. There is also a music button 140 with a “start” command to turn-on the music and a “stop” command which will turn off any music.

Similarly, there is also an exit button 150 associated with the computerized system 10. When the user clicks on “exit” during the program lessons, the user will be on the main page with part of the Armenian alphabet. There is an “UnloadMovie” command that can be used to exit from the lesson and a “loadMovie” command used to open the main page. When the exit button 150 is clicked from the main page, a text will appear asking the user “Are you sure you want to exit the program?”. If “no”, the program will continue, if “yes” they will exit using the “fscommand” to exit the program completely.

It is to be understood that the present invention is not limited to the embodiment described above, but encompasses any and all embodiments within the scope of the following claims.

1. A system of teaching letters and numbers of a foreign language, comprising:
at least one server computer having a processor, an area of main memory for executing program code under the direction of the processor, a storage device for storing data and program code, and a bus connecting the processor and the storage device;
at least one relational database stored on said storage device;
a data communications device connected to said bus for connecting said server computer to the Internet; and
a Web based teaching alphabet letters and numbers of a foreign language computer program code stored in said storage device and executing in said main memory under the direction of said processor, the computer program including:
Web server software means for teaching alphabet letters and numbers of a foreign language on at least one Web site on the Internet;
means for selecting an alphabet letter and a number of a foreign language;
means for selecting an animated object associated with the alphabet letter and the number;
means for viewing an animated process associated with the animated object, and
means for exiting the Web server software means.

2. The system according to claim 1, including means for requiring a user to register his or her first name, last name, mailing address, e-mail address and 16 digit serial number.

3. The system according to claim 1, including means for permitting the user to color an image on a computer screen of the server computer.

4. The system according to claim 3, including means for printing the image for coloring.

5. The system according to claim 1, including means for permitting the user to accompany the image with music.

6. A computer program product that includes a medium readable by a processor, the medium having stored thereon a set of instructions, causing said processor to teach letters and numbers of a foreign language, comprising:
a first sequence of instructions which, when executed by the processor, causes said processor to select letters and numbers of a foreign language;
a second sequence of instructions which, when executed by the processor, causes said processor to select an animated object associated with the alphabet letters and numbers;
a third sequence of instructions which, when executed by the processor, causes said processor to view an animated process associated with the animated object; and
a fourth sequence of instructions which, when executed by the processor, causes said processor to exit the computer program product.

7. The computer program product according to claim 6, wherein an activity sheets function is provided.

8. The computer program product according to claim 6, wherein a help function is provided.

9. The computer program product according to claim 6, wherein a game function is provided.

10. The computer program product according to claim 6, wherein a music function is provided.

11. The computer program product according to claim 6, wherein an exit function is provided.

12. A computerized method for teaching letters and numbers of a foreign language, comprising the steps of:
selecting a letter and a number of a foreign language;
selecting an animated object associated with the alphabet letter and the number;
viewing an animated process associated with the animated object; and
ending the computerized method.

13. The system according to claim 12, comprising the further step of registering a user first name, last name, mailing address, e-mail address and 16 digit serial number.

14. The system according to claim 12, comprising the further step of coloring an image on a computer screen of the server computer.

15. The system according to claim 14, comprising the further step of printing the image for coloring.

16. The system according to claim 14, comprising the further step of accompanying the image with music.
